(19) United States
(12) Patent Application Publication
(10) Pub. No.: US 2008/0318828 A1
(43) Pub. Date: Dec. 25, 2008

(54) Incorporation of Antioxidant in Detergent Composition

(76) Inventors: Renee Boerefijn, Vlaardingen (NL); Andrew Paul Chapple, Wirral (GB); Bastiaan Domburg, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/921,379

(22) PCT Filed: May 1, 2006
(86) PCT No.: PCT/EP2006/004345

§ 371 Date: Jul. 17, 2008

(30) Foreign Application Priority Data
Jun. 3, 2005 (GB) 0511313.9

(51) Int. Cl. C11D 3/20; C11D 3/00

(52) U.S. Cl. 510/356; 510/276

(57) ABSTRACT

A process for incorporation of up to 2% antioxidant into a granular detergent formulation comprising at least 5% organic surfactant, including the steps of: a) dissolving the antioxidant in an organic surfactant selected from the group comprising anionic surfactant, nonionic surfactant and mixtures thereof, provided that the organic surfactant contains less than 5% by weight, preferably less than 3% by weight soap and most preferably is soap free; and b) adding the solution formed in step a) to the detergent formulation and use of the granular laundry detergent composition to confer improved deposition of the antioxidant onto rubber during a wash process.

The present invention relates to a process for the incorporation of an antioxidant in a granular detergent composition, especially to the incorporation of BHT in a granular laundry detergent composition.

BHT (2,6 ditert-butyl-4-methyl phenol) is an antioxidant. Anti-oxidants such as BHT or propyl gallate are added to laundry detergent formulations to reduce or prevent the effects of oxidation processes. These effects can manifest themselves during storage or during use of the formulation. Examples of the unwanted effects of oxidation processes are: malodour, discoloration, perfume degradation, deactivation of ingredients such as organic surfactants, bleach, enzymes and change in properties of rubber based materials.

Antioxidants are usually provided as water insoluble, non-dispersible solids. This poses a problem if they are to be dispersed efficiently in wash liquor in order to protect fabrics from oxidative effects. BHT is soluble in ethanol. Use of ethanol in a detergent formulation is not ideal because of the volatility of ethanol.

One process used to incorporate BHT in laundry detergent compositions is by co-formulating it with a perfume. However, this is a manufacturing constraint due to the fixed ratio of anti-oxidant to perfume in such a component, which makes it difficult to vary the level of one ingredient independently of the other. This fixed ratio results either in overdosing of one of the ingredients or in a larger number of the mixed ingredient raw materials having different ratios needing to be stocked. It also has an impact on the types of perfume that may be used to avoid possible interaction of the perfume with the antioxidant; for example, BHT gives unwanted discoloration with some perfumes on storage. Combining antioxidant and perfume in this way may also cause problems for obtaining new sources of perfume. It is therefore desirable to seek other ways to incorporate antioxidants, especially BHT, in laundry detergent formulations.

In WO2005054422 Tinogard® (a BHT derivative) is incorporated into a detergent formation to reduce malodour. The Tinogard® is added to the formulation by premixing it with zeolite.

In WO9606151 BHT was added to a PAS formulation by two alternative processes. In the preferred process, the BHT was added to the base powder in the high-speed mixer/granulator as a non-ionic surfactant/soap/BHT mixture. In the second alternative method it was post dosed in powder form. It was also suggested to add a dispersion or solution of antioxidant to the base powder by dissolving or dispersing it into a nonionic surfactant. Alternatively, the postdosed method may be adapted to form granules on a carrier material with a binder. There is no suggestion to postdose the nonionic variant. This patent application is concerned with the problem of preventing oxidation of PAS at high temperatures during production. Hence, the preference to add the antioxidant to the base powder and to post dose after the antioxidant is present.

In EP 1302 442 a liquid detergent composition containing hydrogen peroxide is stabilised by addition of sterically hindered amines. The compositions may contain surfactant and, in a comparative example, BHT is used. It is added to the liquid composition dissolved in nonionic surfactant (a C₁₃₋₁₅ fatty alcohol ethoxylated with an average of 7 moles of ethylene oxide). The amount of nonionic surfactant added is 0.5 wt % of the full composition to deliver 0.02 wt % BHT. Thus, the loading of BHT in the nonionic surfactant is 4 wt %.

According to the present invention a process for incorporation of up to 2% antioxidant into a granular detergent formulation comprising at least 5% organic surfactant, includes the steps of
a) dissolving the antioxidant in an organic surfactant selected from the group comprising anionic surfactant, nonionic surfactant and mixtures thereof, provided that the organic surfactant contains less than 5% by weight, preferably less than 3% by weight soap and most preferably is soap free; and
b) adding the solution formed in step a) to the detergent formulation.

The organic surfactant is preferably water free and highly saturated. The organic surfactant used in step a) advantageously comprises less than 1% free water and furthermore it desirably contains no ethylenic unsaturation.

More preferably, the surfactant is anionic or nonionic. Nonionic surfactants are the most preferred due to these surfactants being commonly available in a water-free form. Ethoxylated fatty alcohols are the preferred class of nonionic surfactants because of their ability to dissolve up to 40 wt % of the antioxidant, particularly BHT. It is advantageous to dissolve at least 20 wt % antioxidant into the surfactant so that to get a typical loading of 0.02 wt % antioxidant into the granular detergent composition it is necessary to add as little as 0.05 and typically about 0.1 wt % of organic surfactant to the powder in the incorporation step. The nonionic surfactant preferably has from 5 to 40 ethylene oxide units. It also preferably has from 8 to 45 carbon atoms in its backbone.

The ratio of surfactant to antioxidant in step a) is in the range 1000:1 to 1:1, preferably 10:1 to 2:1.

The antioxidant is preferably selected from the group comprising BHT and propyl gallate, most preferably BHT.

The organic surfactant may be pre-heated to assist in the dissolution of the antioxidant.

Throughout this specification references to antioxidants also include free radical scavengers, except where the context would make this impossible.

Suitable free radical scavengers for use herein include the well-known substituted mono and dihydroxy benzenes and their analogs, alkyl and aryl carboxylates and mixtures thereof. Preferred such radical scavengers for use herein include di-tert-butyl hydroxy toluene (BHT), hydroquinone, ditert-butyl hydroquinone, mono-tert-butyl hydroquinone, tert-butyl-hydroxy anysole, benzoic acid, toluic acid, catechol, t-butyl catechol, benzylamine, 1,1,3-tris(2-methyl-4-hydroxy-5-t-butylphenyl)butane, n-proyl-gallate or mixtures thereof and highly preferred is di-tert-butyl hydroxy toluene. Such radical scavengers like N-propyl-gallate may be commercially available from Nipa Laboratories under the trade name Nipanox S1®. Radical scavengers when used, are typically present herein in amounts ranging from up to 10% and preferably from 0.001% to 0.5% by weight of the total composition.

The compositions made according to the invention may comprise further antioxidant or mixtures thereof.

Suitable further antioxidants to be used herein include organic acids like citric acid, ascorbic acid, tartaric acid, adipic acid and sorbic acid, or amines like lecithin, or amino acids like glutamine, methionine and cysteine, or esters like ascorbil palmitate, ascorbil stearate and triethylcitrate, or mixtures thereof. Preferred antioxidants for use herein are citric acid, ascorbic acid, ascorbil palmitate, lecithin or mixtures thereof.

This manufacturing process has been shown to have the benefit of improving the efficacy of the anti-oxidant. Thus it can be used at a lower level to obtain the same efficacy or it can be used at the same level to obtain even better protection of detergent ingredients and laundry.

Furthermore, because the antioxidant can be dissolved into the surfactant easily during the detergent formulation manufacturing process, there is no longer the restriction of having to have two components like perfume and anti-oxidant in a fixed ratio. The only restriction is that there should be enough surfactant in the formulation to dissolve all the antioxidant. Typically, for nonionic surfactant, the minimum level is a 2:1 weight excess over the antioxidant although it is possible to dissolve up to 40 wt % BHT in some surfactants. It is preferred for the surfactant to be selected from those already present in the formulation. However, an additional surfactant may also be employed. Incorporation of BHT by dissolution in nonionic has been found to give particularly good protection of rubber based materials from catalysed oxidation systems during the wash.

According to a second aspect of the invention there is provided the use of a granular laundry detergent comprising an antioxidant dissolved in ethoxylated nonionic surfactant to confer improved deposition of the antioxidant onto rubber during a wash process.

A preferred process for manufacture of a powdered detergent formulation is to add the antioxidant in a nonionic surfactant by spraying this mixture onto the powder whilst the powder is being mixed. A drum mixer or other suitable process may be used to perform this method of incorporation. Suitable alternative mixers include fluidised beds and double cone mixers.

The granular laundry detergent formulation, or powder, is not limited: provided it contains organic surfactant. It may comprise mixtures of organic surfactants such as anionic and nonionic surfactant. It may comprise builders and other ingredients commonly found in detergent powder formulations. The composition may be low medium or high bulk density and may be produced by any of the processes known in the art.

The invention will now be further described with reference to the following non-limiting examples.

### EXAMPLE 1

BHT was dissolved in a C12-15 fatty alcohol nonionic surfactant ethoxylated with an average of 7 moles of ethylene oxide. It was found possible to dissolve up to 40 wt % of BHT in the organic surfactant. In a variant of this procedure it was found easily possible to dissolve 30 wt % of the antioxidant in Synperonic A05 nonionic surfactant.

### EXAMPLE 2

A 30 wt % solution of BHT in nonionic organic surfactant as described in example 1 was sprayed in a drum mixer onto a phosphate built granular detergent composition containing LAS as anionic surfactant in an amount so as to give 0.02 wt % of BHT in the finished granular detergent. Because so little nonionic surfactant was added in this way there was no need for any further process operation.

### EXAMPLE 3

Control A: Laundry powder without BHT
Control B: Laundry powder with 0.02% BHT added in perfume

### EXAMPLE 4

### Laundry Powder with 0.02% BHT Added in Nonionic Surfactant as Described in Example 2

The BHT was supplied by Fluka.

Two tests were carried out.

### Test 1

In this test, we investigated the effect of the method of incorporation of the BHT on the quantity of BHT found in the wash liquor. This test indicates how well the composition stores and then disperses the BHT into solution. Analysis is done by means of ABTS. In each case, the wash liquor is made up using 6FH water. ABTS reaction times of 15 mins on solutions were used.

The results are shown in table 1 below:

TABLE 1

| | % BHT | Product | % Recovered | | |
|---|---|---|---|---|---|
| Ex | Nominal | dose g/l | 5 mins | 10 mins | 20 mins |
| A | 0 | 8 | 0 | 0 | 0 |
| B | 0.02 | 8 | 0 | 48 | 47 |
| 4 | 0.02 | 8 | 63 | >98 | >98 |

Comparison of the perfume route (B) with the nonionic route (4) shows much better availability of the BHT in the wash when added via the nonionic. NB that due to solubility constraints the wt % BHT in the perfume could only be about 6 wt % maximum. Thus, the amount of spray on needed to be much larger for example B than for example 4.

### Test 2

For this test, the formulations used for Test 1 were used to wash rubber-based materials eight times each. BHT was then extracted from the material to see how much had been absorbed or deposited during the 8 washes, using the value for Example A as the base line. The results are given in Table 2.

TABLE 2

| Ex. | mMol BHT/kg |
|---|---|
| A | 0 |
| B | 0 |
| 4 | +0.4 |

It can be seen that the most effective process for incorporation is the process according to the invention—example 4. The use of the perfume process is clearly not as effective as the use of non-ionic surfactant.

1. A process for incorporation of up to 2% antioxidant into a granular detergent formulation comprising at least 5% organic surfactant, including the steps of
a) dissolving the antioxidant in an organic surfactant selected from the group comprising anionic surfactant, nonionic surfactant and mixtures thereof, provided that the organic surfactant contains less than 5% by weight, preferably less than 3% by weight soap and most preferably is soap free; and
b) adding the solution formed in step a) to the detergent formulation.

2. A process as claimed in claim 1 wherein the organic surfactant used in step a) comprises less than 1% free water.

3. A process as claimed in claim 1 wherein the organic surfactant used in step a) contains no ethylenic unsaturation.

4. A process as claimed in claim 3 wherein the organic surfactant is a nonionic surfactant.

5. A process as claimed in claim 4 wherein the nonionic surfactant has from 5 to 40 ethylene oxide units.

6. A process as claimed in claim 5 wherein the nonionic surfactant has from 8 to 45 carbon atoms in its backbone.

7. A process as claimed in claim 1 in which the organic surfactant is heated to dissolve the antioxidant.

8. A process as claimed in claim 1 in which the antioxidant is selected from the group comprising BHT and propyl gallate, preferably BHT.

9. A process as claimed in claim 1 in which the ratio of surfactant to antioxidant in step a) is in the range 1000:1 to 1:1, preferably 10:1 to 2:1.

10. Use of a granular laundry detergent composition comprising an antioxidant dissolved in ethoxylated nonionic surfactant to confer improved deposition of the antioxidant onto rubber during a wash process.
